(19) United States
(12) Patent Application Publication
(10) Pub. No.: US 2014/0172689 A1
(43) Pub. Date: Jun. 19, 2014

(54) FUNGIBLE MONETIZATION OF MEDIA

(71) Applicant: RAWLLIN INTERNATIONAL INC., Tortola (VG)

(72) Inventors: Sergey Stepanov, Sankt-Petersburg (RU); Ivan Grodetsky, Sankt-Peterburg (RU); Artem Kirakosyan, St. Petersburg (RU); Vitaly Grigorash, Sankt-Petersburg (RU)

(73) Assignee: RAWLLIN INTERNATIONAL INC., Tortola (VG)

(21) Appl. No.: 13/715,931

(22) Filed: Dec. 14, 2012

(51) Int. Cl. G06Q 20/22

(52) U.S. Cl. CPC G06Q 20/22
USPC 705/39

(57) ABSTRACT

Flexible managing and monetizing of multimedia content are applied in a distribution network. Credit amounts to charge to accounts are determined. Content servers can determine alter access to and ownership of services and/or multimedia content. Services and content can be purchased and/or altered during multimedia playback.

### TECHNICAL FIELD

This disclosure generally relates to managing and distributing multimedia content.

### BACKGROUND

Multimedia content is becoming widely accessible to users, such as in the form of movies, television shows, streaming video, audio, and electronic books. Likewise, users are increasingly purchasing or renting multimedia items over the Internet, wireless networks, and the like.

Multimedia players enable playback of the multimedia content. Multimedia players are increasingly available on a range of consumer devices, from set top boxes to mobile devices. Multimedia players connected to a network enable users to purchase and to playback multimedia items on demand. Multimedia content is available for purchase on demand for users that are connected to a network.

The above-described background is merely intended to provide an overview of some general context for the present application, and is not intended to be exhaustive.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

A content provider can provide multimedia (e.g., video, audio, digital content) to a consumer via a store. A store can be a physical or online store (e.g., enabled through cloud computing for example). The store can offer the multimedia for purchase subject to a purchase agreement. The purchase agreement can provide terms such as credit amount, user identification, length of ownership, ownership status (e.g., rent, own), and the like. In one example, a user can desire to alter a purchase agreement. An alteration of a term of the agreement can automatically adjust other terms of the agreement. For example, a user can rent a media item for a period of 30 days at a price of five dollars. After the user has enjoyed the media item for 10 days, the user can desire to own the media item outright (e.g., purchase the media item as opposed to rent). An adjustment can be automatically made to alter the purchase agreement terms, such as altering the payment amount and altering the ownership status.

As another example, a multimedia item can be played back on a device according to a purchase agreement. Multimedia playback can include streaming, viewing, and/or causing a multimedia item to be performed on a user device. The purchase agreement can provide for a number of terms, including a specific multimedia item quality (e.g., HD, standard, etc.). As the media item is played back, a user can alter terms of the purchase agreement. For example, a user can play back a multimedia item on a mobile device. During playback a user can decide to alter the quality of the multimedia item (e.g., switch from standard to HD). A user interface can collect user input indicative of a desired alteration and can seamlessly or near-seamlessly alter the multimedia playback and the purchase agreement according to the user input.

In another example, a communication network can provide for fungible monetization of multimedia items in a cloud computing environment. The communication network can provide multimedia content to user device according to a purchase agreement. A user can alter the purchase agreement and switch to a disparate multimedia item via the communication network. Further, the credit can be applied to another multimedia item. As an example, a user can purchase a multimedia item and, after purchasing, decide to relinquish ownership for credit to use towards a disparate multimedia item (e.g. relinquish ownership of a first multimedia item for partial credit towards a sequel).

Other embodiments and various non-limiting examples, scenarios and implementations are described in more detail below. The following description and the drawings set forth certain illustrative aspects of the specification. These aspects are indicative, however, of but a few of the various ways in which the principles of the specification may be employed. Various embodiments of the specification will become apparent from the following detailed description of the specification when considered in conjunction with the drawings.

### BRIEF DESCRIPTION OF THE DRAWINGS

Numerous aspects and embodiments will be apparent upon consideration of the following detailed description, taken in conjunction with the accompanying drawings, in which like reference characters refer to like parts throughout, and in which:

FIG. 1 illustrates a high-level functional block diagram of an example system for controlling and/or managing multimedia items and/or purchasing of multimedia items, in accordance with various aspects and implementations described herein;

FIG. 2 illustrates a high-level functional block diagram of an example server system for controlling and/or managing multimedia items and/or purchasing of multimedia items, in accordance with various aspects and implementations described herein;

FIG. 3 illustrates a high-level functional block diagram of an example computing system for controlling and/or managing multimedia items and/or purchasing of multimedia items, in accordance with various aspects and implementations described herein;

FIG. 4 presents an exemplary representation of an interface device configured to present a multimedia item and provide embedded purchasing, in accordance with various aspects and implementations described herein;

FIG. 5 illustrates a high-level functional block diagram of an example networked system for controlling and/or managing multimedia items and/or purchasing of multimedia items including a content provider and content viewer, in accordance with various aspects and implementations described herein;

FIG. 6 illustrates a method for processing a request to alter a purchase agreement, in accordance with various aspects and implementations described herein;

FIG. 7 illustrates a method for determining a credit amount, in accordance with various aspects and implementations described herein;

FIG. 8 illustrates a method for controlling and/or managing purchases of multimedia items during playback of a multimedia item, in accordance with various aspects and implementations described herein;

FIG. 9 illustrates a block diagram representing an exemplary non-limiting computing system or operating environment in which one or more aspects of various non-limiting embodiments described herein can be implemented; and

FIG. 10 illustrates a block diagram representing exemplary non-limiting networked environments in which various non-limiting embodiments described herein can be implemented.

### DETAILED DESCRIPTION

In the following description, numerous specific details are set forth to provide a thorough understanding of the embodiments. It is noted, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” “an embodiment,” “one implementation,” or “an implementation” means that a particular feature, structure, or characteristic described in connection with the embodiment or implementation is included in at least one embodiment or implementation. Thus, the appearances of the phrase “in one embodiment,” “in an embodiment,” “in one implementation,” or “in an implementation,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

As used herein, the terms “multimedia,” “multimedia item,” “media item,” “media content,” and the like are utilized interchangeably, unless context suggests otherwise. These terms are intended to relate to an electronic media product and include video items, audio-video items, audio items, text items, electronic book (E-book) items, still image items, streaming video, streaming audio, and so forth. For example, a multimedia media item can include a movie, a live television program, a recorded television program, a streaming video clip, a user-generated video clip, a video game, an audio file, a text file, etc. Further, the terms are related to any number of file formats or encoding formats (e.g., Moving Picture Experts Group (MPEG), MPEG-2, MPEG-1 audio layer (MP3), ITU-T Video Coding Experts Group (VCEG), H.26x, wherein x is a generation, text, etc.). Moreover, the terms can include items utilizing digital rights management (DRM) techniques to control access to media content.

As used herein, the terms “purchase,” “rent,” “buy,” and the like are utilized interchangeably, unless context suggests otherwise. The terms are intended to relate to a purchase agreement for ownership of a multimedia item, or copyright license of a multimedia item. As such, the ownership can be for a predefined time period, indefinite time period, portion of a media item, complete media item, a series or collection of media items, or otherwise.

Further, as used herein, the terms “credit,” “credited,” “debit,” “debited,” “charge,” and the like are used interchangeably, unless context suggests otherwise. The terms are intended to relate to an amount to be added or deducted to an account. For example, a “credit” can be a negative or positive amount. While at other times, as suggest by context, “credit” can refer to applying a negative or positive amount to an account.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

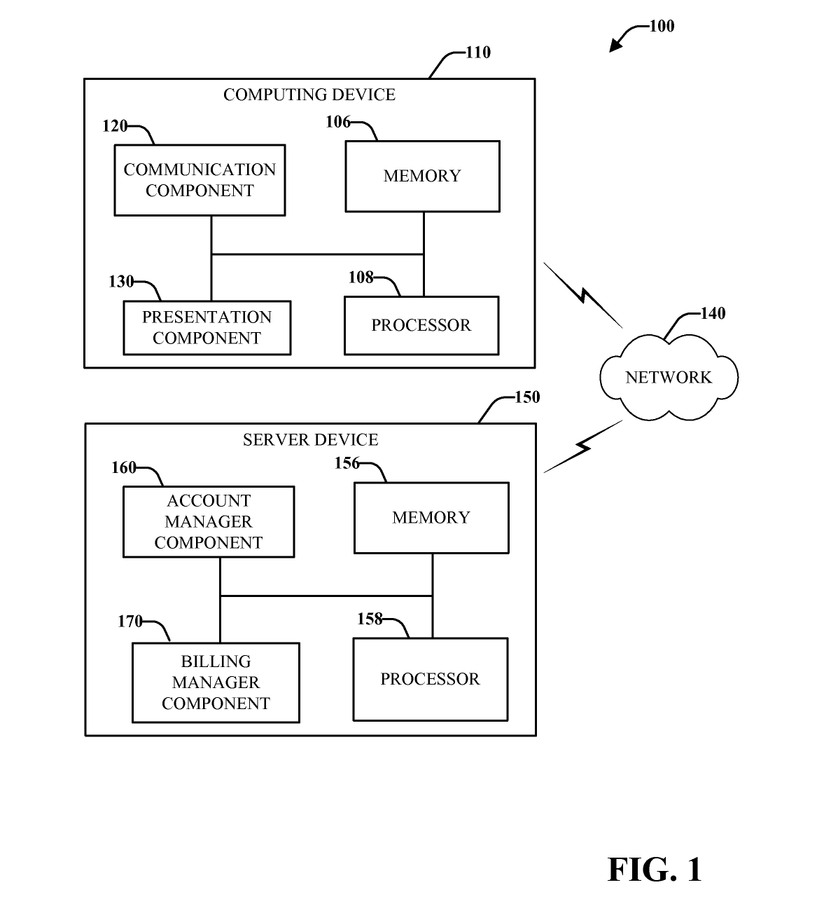

Referring now to the drawings, with reference initially to FIG. 1, a system 100 for controlling and/or managing media content access and distribution is provided, in accordance with various aspects described herein. Aspects of the systems, apparatuses or processes explained herein can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described.

The system 100 is configured to control and/or manage a multimedia content element and/or information associated with in a multimedia purchasing and distribution network. The system 100 includes a computing device 110 comprising a memory 106 for storing computer executable components and instructions. A processor 108 can facilitate operation of the computer executable components and instructions by the computing device 110. As depicted, the system 100 also includes a server device 150 comprising a memory 156 for storing computer executable components and instructions. A processor 158 can facilitate operation of the computer executable components and instructions by the server device 150. The server device 150 and computing device 110 can be coupled by a network 140 (e.g., the Internet, intranet, Ethernet, cellular network, etc.).

The computing device 110 can be implemented as any type or class of electronic device, such as a desktop computer, laptop computer, mobile device (e.g., smart phone, personal digital assistant (PDA), tablet computer, electronic book reader (e-reader), mobile phone, hand-held gaming system, and music player), set top box, television, and the like. In one aspect, the computing device 110 can include a communication component 120, and a presentation component 130.

The presentation component 130 can provide multimedia playback via an interface to a user. Multimedia playback can include streaming, viewing, and/or causing a multimedia item to be performed. In some implementations, the presentation component 130 can include a liquid crystal display (LCD), a touch screen display, an electronic paper display, a computer monitor, a television screen, an audio speaker, a combination of displays, and the like. Moreover, the presentation component 130 can include multimedia players (e.g., a computer-executed program interacting with a host application), such as video players, audio players, plug-ins, codecs, and the like.

The communication component 120 can receive media via the network 140 from the server device 150. It is noted that media can be received in various other ways, such as via another computing device, another server device, and the like. The communication component 120 can include communication interfaces (e.g., transmitters, receivers, radios, antennas, communication ports, and the like) utilizing protocols to send and receive data via the network 140.

The server device 150 can comprise an account manager component 160 and a billing manager component 170. While shown as a single block, it is noted that the server device 150 can comprise one or more devices, such as computers, blade servers, central servers, an application server, a data server, and the like.

In an embodiment, the server device 150 can provide data (e.g., a stream of video, stream of audio, packeted data) to a client device, such as the computing device 110. In an aspect, the server device 150 can communicate with the computing device (e.g., via the communication component 120). As an example, communication can occur via a transport control protocol (TCP) connection using hypertext transport protocol (HTTP) calls and the real time messaging protocol (RTMP).

The account manager component 160 can manage a user account associated with the computing device 110. In an aspect, the account manager 160 can store accounts for users in the memory 156, for example. The accounts can comprise data fields such as a user identifier, a password, a credit card number (including expiration date), a delivery address, a list of active devices, and the like. In an embodiment, the account manager component 160 can store multimedia items associated with a user (e.g., previously purchased multimedia items, recently viewed multimedia items, etc.).

As an example, a user can interact with the computing device 110 to communicate with the server device 150 via the network 140. The communication can include communication of data fields, such as user identification, user login credentials, a media item selected for purchase, a media item selected for playback, and the like. In an aspect, the server device 150 can respond to requests made by the computing device 110 via the network 140. The account manager component 160 can grant a user access to a particular multimedia item. Access can include allowing the computing device 110 to stream, download, or otherwise make use of the multimedia item.

Additional or alternatively, the account manager component 160 can comprise security protocols and/or measures. As an example, the account manager component 160 can facilitate encryption and/or decryption of data. Further, the account manager component 160 can manage data fields in a secure manner, such that user accounts are protected.

The billing manager component 170 can manage billings of user accounts. In one embodiment, a user can interact with the computing device 110 to select a media item for purchase. Purchase can include purchase of a limited time license (e.g., rental), an indefinite time license (e.g. outright ownership, permanent ownership, etc.), a preview, a portion of a multimedia item (e.g., chapters of books, levels of video games, tracks of an album, etc.) and the like. In one aspect, the billing manager component 170 can manage (e.g., offer for purchase) multiple versions of a multimedia item (e.g., high definition, three dimensional (3D), audio only, full video, text, etc.). In another aspect, the billing manager component 170 can manage rental of a multimedia items according to terms of an agreement (e.g., length of time for rental, a number of views, a price, etc.).

In an embodiment, the billing manager component 170 can manage purchase agreements. A purchase agreement can include purchase terms such as multimedia item identifiers, length of ownership (e.g., number of days), price, type of ownership (e.g., outright ownership, rental, etc.), and the like. In an embodiment, a user can select a purchase agreement, associated with a multimedia item that was previously purchased by the user, for alterations and the billing manager component 170 can process the alteration.

As an example, a user can interact with the computing device 110 to send a request to the server device 150. The request can indicate that the user desires to rent a multimedia item. The billing manager component 170 can manage a purchase agreement that provides terms, such as a period of i days at a price of j tokens (e.g., currency, credits, etc.), where i and j are real numbers. Further, the user can decide to alter a term of the purchase agreement, such as changing from rental to permanent purchase of the multimedia item. The user can communicate the term desired for alteration with the computing device 110 and the billing manager component 170 can alter the purchase agreement and/or create a new purchase agreement according to the term. It is noted that a purchase agreement can be altered to form a new purchase agreement or a completely new purchase agreement can be created. Accordingly, as used herein, an “altered purchase agreement,” a “new purchase agreement,” and the like are used interchangeable unless context suggests otherwise.

In various exemplary embodiments, the billing manager component 170 can provide flexible management of purchase agreements and/or multimedia items to determine dynamic monetization policies. The billing manager component 170 can employ dynamic monetization policies to determine a credit amount to be applied (e.g., added or subtracted) and/or terms to be altered as a function of requested alterations, terms of an unaltered service agreement (original terms), elapsed time, a relationship between multimedia items to be purchased (e.g., a sequel), and the like. Further, in an embodiment, the billing manager component 170 can determine relationships between multimedia items for utilization by the dynamic monetization policies. Relationships can be entered by users, determined automatically, and the like. As an example, billing manager component 170 can automatically define a relationship by comparison of multimedia items (e.g., comparison of actors in a movie, artists performing a song, author of books, titles, etc.).

As an example, the billing manager component 170 can determine a credit amount to be applied as a function of elapsed time. In an aspect, a credit amount can decrease as time elapses. As another example, the billing manager component 170 can determine a credit amount as a function of a relationship. In an aspect, a relatively larger credit amount is determined to be applied if the credit is applied to a related multimedia item as opposed to an unrelated multimedia item, etc. As another example, a user can rent a multimedia item for a predetermined time period. Before the time period ends, the user can communicate a request to purchase the multimedia item. The billing manager component 170 can utilize a dynamic monetization policy to process the request by determining a credit amount and altering an ownership status associate with the user and the multimedia item.

In an embodiment, the presentation component 130 can present purchasing options to a user. In an aspect, the presentation component 130 can present the purchasing options regarding the multimedia item during playback of the multimedia item. For example, the purchasing options can be presented by a menu in an interface of the computing device 110 during playback of the multimedia item on the computing device 110. The purchasing options can represent available requests a user can make to alter a purchase agreement according to a dynamic monetization policy. The purchasing options can be activated during playback of the multimedia item on the computing device 110 by a user selecting a purchasing option. As such, the billing manager component 170 can receive and/or process requests during playback, in accordance with various aspects of this disclosure.

The presentation component 130 can allow transition between multimedia items (or versions of multimedia items) during playback. In one example, an alteration is requested by clicking a purchasing option associated with the multimedia during playback. The server device 150 can receive the request via the network 140 and can process the request, such that the data indicative of the request is transmitted to communication component 120. For example, a requested alteration can comprise a request to alter a playback format to a selected playback format (e.g., switch from a standard video to a 3D video, alter video quality, etc.). The server device 150 can receive the request and provide the computing device 110 with the multimedia item in the selected playback format via the network 140.

In one embodiment, the presentation component 130 can present one or more prompts to a user (e.g., via an interface). The presentation component 106 can present a prompt to verify a user's selection of a purchasing option, verify a user's credentials, indicate compatible formats with the computing device 110, offer addition options and/or products, and the like. In an aspect, the presentation component 130 can determine the display requirements of a user device, such as screen size and/or configuration. In addition, in an aspect, the presentation component 130 can determine the layout and/or configuration of a screen with a multimedia player for the multimedia item. In turn, the presentation component 130 can be configured to present a prompt with a type, size, shape, and/or orientation, which fits the display requirement of an interface of the computing device 110.

While FIG. 1 depicts separate components in system 100, it is to be appreciated that the components may be implemented in a common component. In one example, the communication component 120 and the presentation component 130 can be included in a single component. Further, it can be appreciated that the design of system 100 can include other component selections, component placements, etc., to control and/or manage multimedia content.

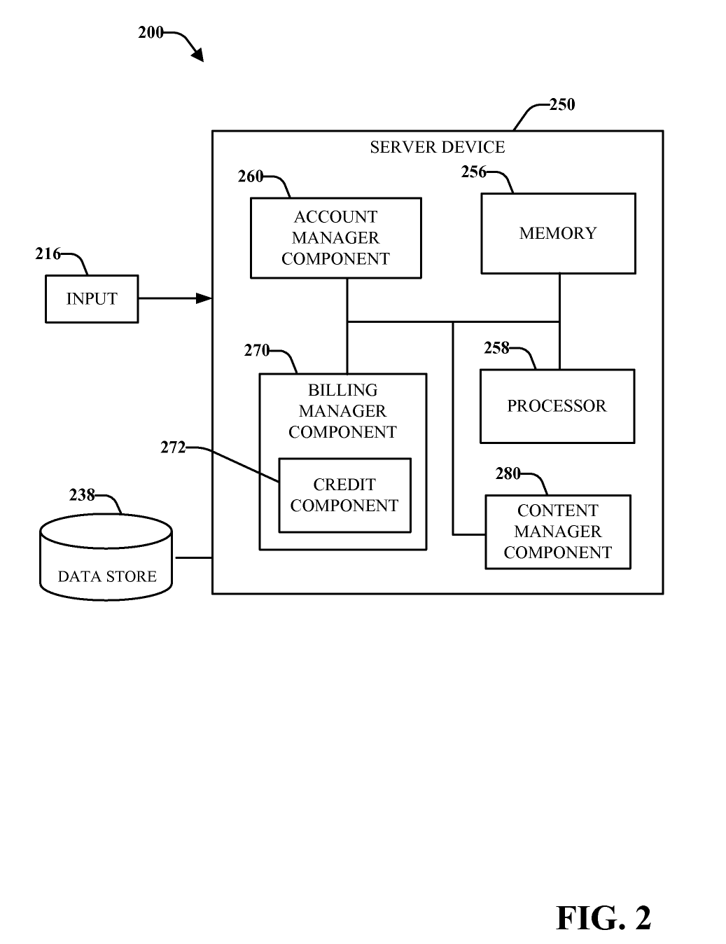

Referring now to FIG. 2, illustrated is a non-limiting implementation of a system 200 for providing fungible monetization of multimedia items, in accordance with various aspects and implementations of this disclosure. The system 200 includes a server device 250 comprising a memory 256 for storing computer executable components and instructions. A processor 258 can facilitate operation of the computer executable components and instructions by the server device 250. The computer executable components can comprise an account manager component 260, a billing manager component 270, and a content manager component 280. The billing component 270 includes a credit component 272. In an aspect, the account manager component 260 can comprise functionality similar to the account manager component 160 of FIG. 1.

The content manager component 280 can manage access to multimedia items stored in a data store 238. In an aspect, access can include delivery, viewing, streaming, and the like. It is noted that content manager component 280 can provide data to a client device via a network (e.g., internet, intranet, etc.) utilizing a communication interface such as TCP and/or HTTP. The content manager component 280 can access account information managed by the account manager component 260. The content manager component 280 can process the account information to determine if a user device has permission to access a multimedia item.

In an embodiment, the content manager component 280 can manage multimedia items, and information related to the multimedia items, stored in the data store 238. The content manager component 280 can search, index, or otherwise manage the multimedia items according to information identifying and/or classifying the multimedia items. Additionally or alternatively, the content manager component 280 can determine relationships between multimedia items. In various embodiments, the content manager component 280 can determine a relationship between one or more multimedia items based on input from users (e.g., input 216), predefined relationships, stored information relating to the multimedia items (e.g., identification fields, titles, actors, authors, artists, etc.), and the like.

In another aspect, the content manager component 280 can track delivery and use of multimedia items. For example, the content manager component 280 can track access requests for multimedia items made by a device associated with an account managed by the account manager 260. Further, the content manager component 280 can employ DRM techniques to manage access to multimedia items.

The billing manager component 270 can comprise functionality similar to that of the billing manager component 170 of FIG. 1. In another aspect, the billing manager 270 can comprise a credit component 272 employed to execute debits and/or credits to an account, such as a user's credit card account, debit account, or any other account. Further, credit component 272 can initiate fund transferring to accounts, such as service provider accounts, user accounts, and the like.

In one embodiment, the credit component 272 can determine credits to be applied to an account in response to the input 216 received by the server device 250. The input 216 can represent requests from client devices for alterations to service agreements. In an aspect, the billing manager component 270 can determine alterations to terms of a purchase agreement and employ the credit component 272 to adjust credits associated with a user account.

In an example, the credit component 272 can determine an amount to credit a user's account as a function of the requested alterations, in accordance with various aspects of this disclosure. As an example, the credit component 272 can employ algorithms to determine credits or debits in a flexible manner. Flexible determination of debits and credits can enable users to alter purchases as they desire. When able to alter purchases, users can be more willing to make an initial purchase. Applying credit from previous purchase agreements to new and/or altered purchase agreements can encourage additional spending to increase a content provider's profit.

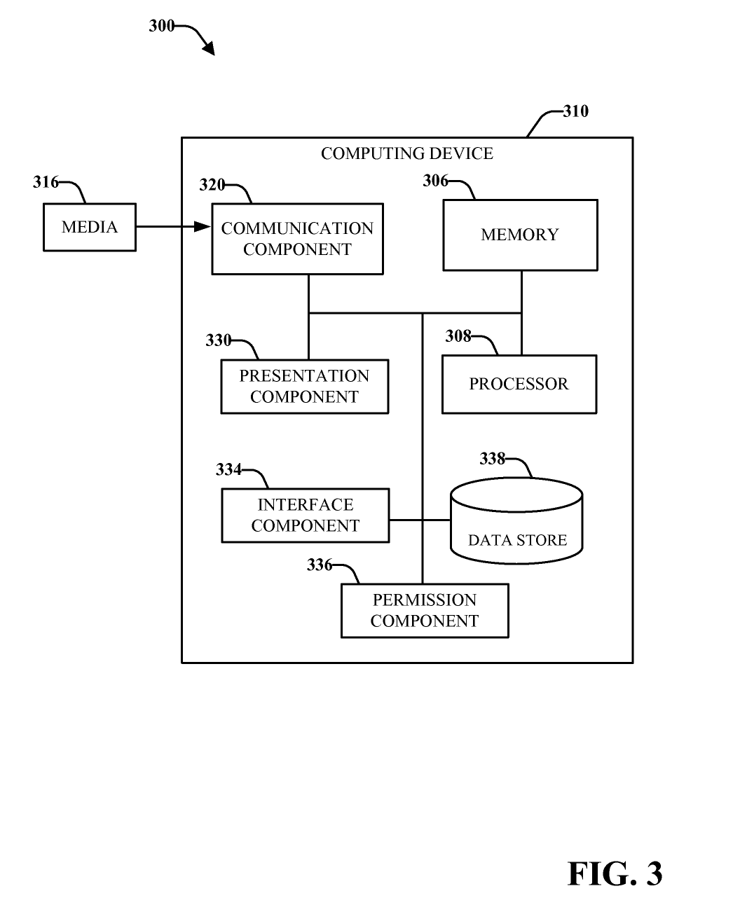

Referring now to FIG. 3, illustrated is a non-limiting implementation of a system 300 for providing fungible monetization of multimedia items, in accordance with various aspects and implementations of this disclosure. The system 300 includes a computing device 310 comprising a memory 306 for storing computer executable components and instructions. A processor 308 can facilitate operation of the computer executable components and instructions by the computing device 310. The computer executable components can comprise a communication component 320, a presentation component 330, an interface component 334, and a permission component 336. In an aspect, the communication component 320 and the presentation component 330 can respectively comprise functionality similar to the communication component 120 and the presentation component 130 FIG. 1.

The interface component 334 can provide an interface to present multimedia items (e.g., media 316). In one aspect, the interface component 334 can receive instructions from presentation component 330 to playback multimedia items. For example, the interface component 334 can receive a video file to be played on a video player (e.g., embedded video player on a website, video player software, etc.).

Additionally or alternatively, the interface component 334 can collect input from a user. The interface component 334 can comprise human interface devices (e.g., mouse, keyboard, touch screen, microphone, etc.) coupled to the computing device 310. Interaction with the interface component 334 can create data indicative of a user's input.

In an embodiment, the interface component 334 can collect user input during playback of multimedia items. For example, multimedia items can be stored in a data store 338, streamed over a network, or the like. During playback, the interface component 334 can display or perform the multimedia item and collect user input. Further, the interface component can provide a user with purchasing options, in accordance with various aspects of this disclosure.

In various embodiments, the permission component 336 can set sharing rights for sharing the information regarding the content element (e.g., limitations regarding how and/or when a tag can be shared). For example, a content provider (e.g., content operator, content owner, etc.) can set sharing rights for sharing information regarding the content element. In one example, if information added by a particular content consumer relates to a rating of a content element, the information can be presented without limitations (e.g., any content consumer can view the information). However, if the information added by a particular content consumer is, for example, a comment (e.g., a comment related to a content element), then the information can be hidden from all viewers except a circle of friends (or a subset thereof) of the content consumer. Therefore, information can be limited to a select group of content consumer (e.g., viewers).

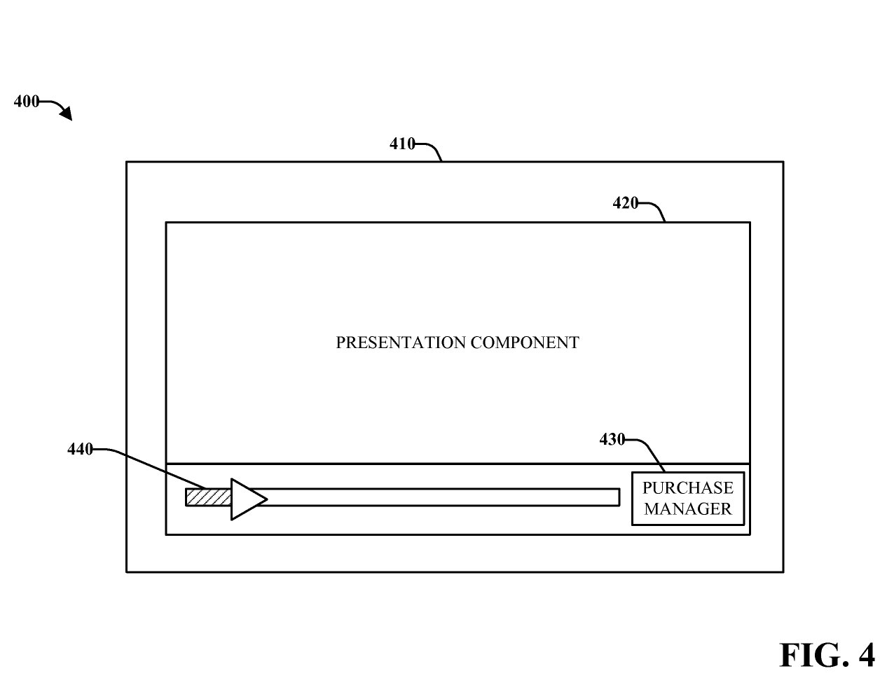

Referring now to FIG. 4, illustrated is a non-limiting implementation of a system 400 that can present multimedia and allow purchase alterations, in accordance with various aspects and implementations of this disclosure. The system 400 includes a multimedia device 410. The multimedia device 410 can include a multimedia presentation component 420. The presentation component 420 can include a purchase manager component 430 and a progress bar 440. It is noted that the multimedia device 410 can include any number of multimedia items stored in a memory, for example. Additionally, it is noted that the multimedia device 410 includes functionality of various aspects of this disclosure, as described by the systems 100-300 with reference to FIGS. 1-3.

The presentation component 420 can comprise a multimedia player, such as a video player, an audio player, a text display, and the like. In an example, the presentation component 420 can embed the purchase manger component 430 within a multimedia player. As another example, a data store or server can provide a multimedia item, such as an audio book, song, video game, movie, television episode, and the like to the presentation component 420. The presentation component 420 can enable playback of the multimedia item.

At any point during presentation, a user might make a purchase using the purchase manger 430. In accordance with various embodiments of this disclosure, the purchase can comprise an alteration of a previous purchase agreement associated with a multimedia item, alteration of a subscription agreement (e.g., reoccurring purchase agreement), creation of a new purchase agreement, and the like. For example, in the case of a video item, the purchase manager component 430 can collect input from a user indicating a user's purchase selection, during playback or otherwise. If the purchase manager 430 determines a selection is made the purchase manager can process the selection. By way of example, the purchase manager 430 can instruct the multimedia player 410 to send a request to a server for a purchase.

In another embodiment, the purchase manager 430 can facilitate a prompt to display on the presentation component 420. The prompt can comprise a request for a user to provide additional information, such as log in credentials, confirmation of a purchase option, and the like. As another aspect, the purchase manager 430 can collect user information and securely transfer the information to a content provider (e.g., to a server).

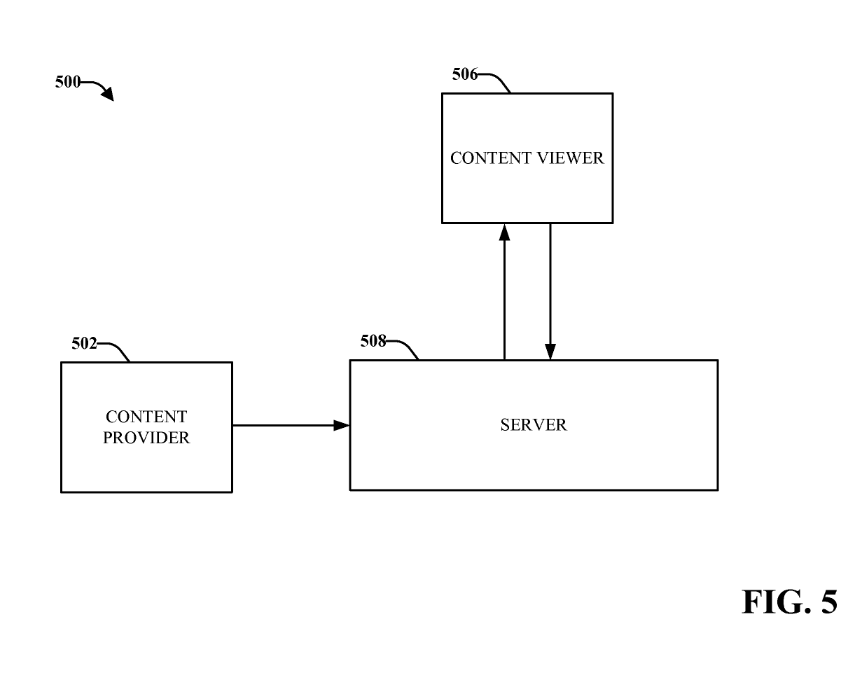

Referring to FIG. 5, illustrated is a non-limiting implementation of a system 500 in accordance with various aspects and implementations of this disclosure. The system 500 includes a content provider (or content providers) 502, a billing manager 504, a content viewer (or content viewers) 506 and a server 508. The content provider 502, the content sponsor 504 and the content viewer 506 can be associated with a user device, such as but not limited to, a desktop computer, a laptop computer, a cell phone, a smartphone, a tablet, a personal computer (PC), an interactive television, an interactive media device, etc. The system 100 can be implemented, for example, on the server 508.

The content provider 502 can provide one or more multimedia items. Additionally, the content provider 502 can manage a user's account and facilitate purchasing of multimedia items.

The billing manager 504 can receive one or more requests to purchase a multimedia item (content). The billing manager 504 can determine an amount to credit and/or debit, in accordance with various aspects of this disclosure.

The content viewer 506 can select (e.g., interact, activate, etc.) one or more tags (e.g., one or more content elements) in a media item (e.g., during playback of a media item). Furthermore, the content viewer 506 can obtain information associated with one or more multimedia items (e.g., detailed information regarding one or more multimedia items, an opportunity to purchase one or more multimedia items, an opportunity to alter a purchase agreement, etc.).

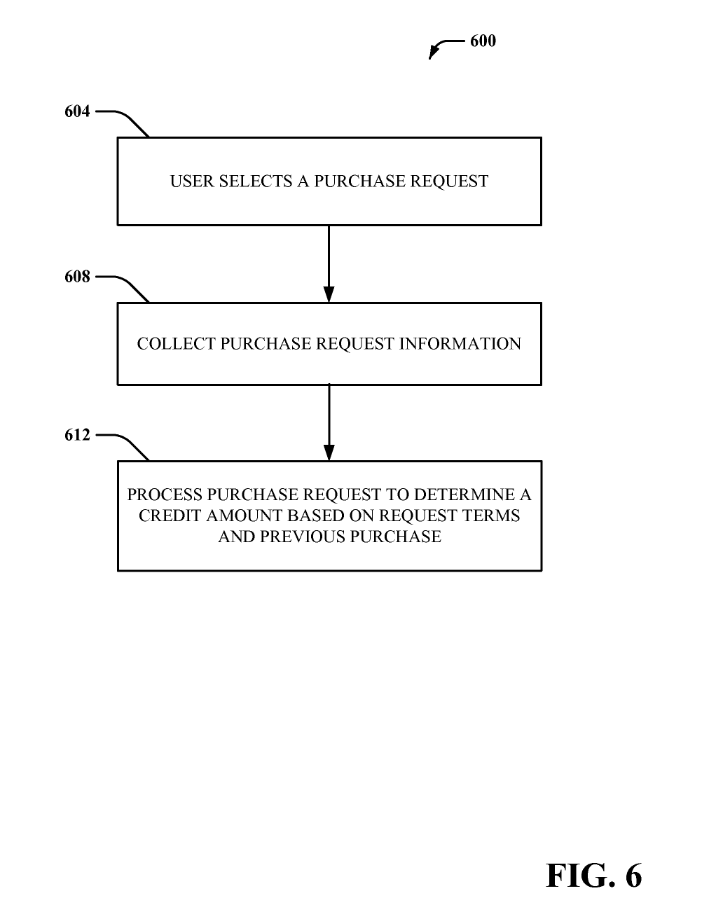

FIGS. 6-8 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, it is noted that a methodology can alternatively be represented as a series of interrelated states or events, such as in a state diagram. Moreover, not all illustrated acts may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers.

Referring now to FIG. 6, presented is an exemplary non-limiting embodiment of a method 600 for controlling and/or managing multimedia item purchases and/or alterations of purchase agreements. At 604, a user can request a purchase (e.g., via system 100). For example, a user can interact with a computing device (e.g., 110) to request a multimedia item for purchase, exchange, etc. The request can comprise a request to alter a previous multimedia item purchase agreement (e.g., request to purchase outright based on a previous purchase agreement associated with a rental of a multimedia item).

At 608, information pertaining to a purchase request is collected, such as an adjustment for a term of a multimedia item purchase agreement and/or new agreement. For example, a request to alter a purchase agreement or make an additional purchase associated with a multimedia item can be received (e.g., by the server device 150).

At 612, a request for a purchase and/or adjustment to a purchase agreement term associated with a multimedia item is processed to determine a credit amount. The request can comprise information associated with a user account and a multimedia item (e.g., account information for billing and/or alteration term). For example, a request can be processed to credit an account and alter a term (e.g., by the server device 150). In an aspect, a credit amount can be determined based on information relating to the request. As an example, a credit amount can be determined based on a new multimedia item selected for purchase.

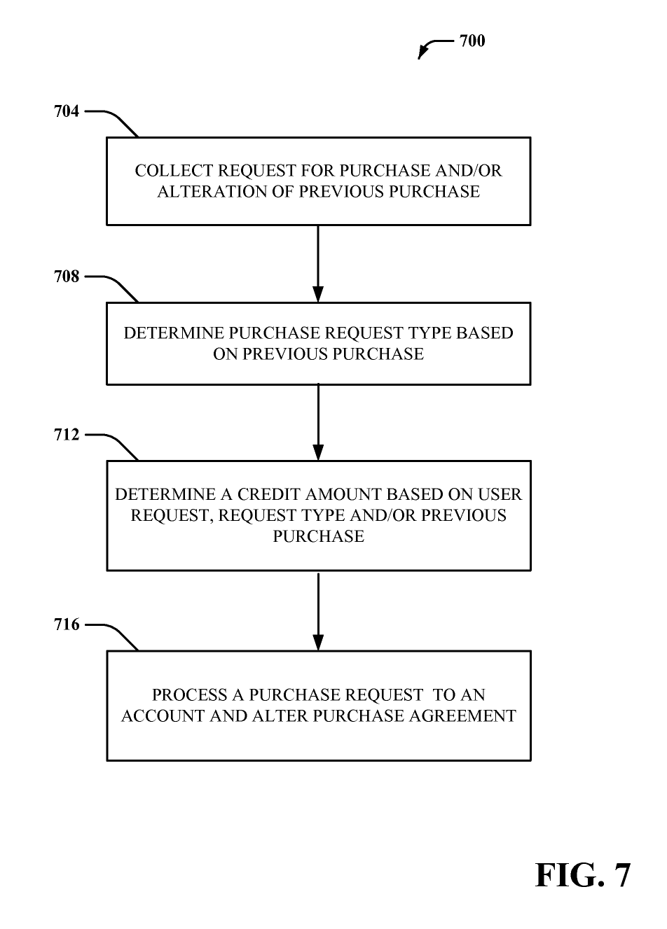

Referring now to FIG. 7, presented is an exemplary non-limiting embodiment of a method 700 for managing a multimedia item purchase according to various aspects of this disclosure. At 704, a request is processed for purchase of a multimedia item (e.g., by the server device 150). For example, a purchase can comprise information relating to an account, one or more purchase terms for alteration, and/or a request for a new purchase agreement. In an aspect, one or more terms can be determined for alteration and/or a previous purchase amount can be determined.

At 708, a type of purchase can be determined (e.g., by the server device 150). For example, a type of purchase can be an extended license and/or a request for a new multimedia item. In one embodiment, the type of purchase can be utilized to determine how a purchase request is processed.

At 712, a credit amount to be applied is determined as a function of the purchase type and/or a previous purchase agreement term (e.g., price). For example, a purchase type indicating a request for an extend ownership (e.g., change from a rental to outright ownership) can result in a credit of a different amount than a purchase type indicating a request for a purchase of a disparate multimedia item (e.g., change from rental of a first multimedia item to rental of a second multimedia item). As another example, a request to purchase a multimedia item for outright ownership after z days of rental can result in a disparate credit amount than a request to purchase a multimedia item for outright ownership after y days of rental, where z and y are real numbers.

At 716, a purchase can be processed according to the credit amount and/or the altered term(s) (e.g., by the server device 150). For example, a credit can be applied to an account and/or an alteration to a term of a purchase agreement can be applied.

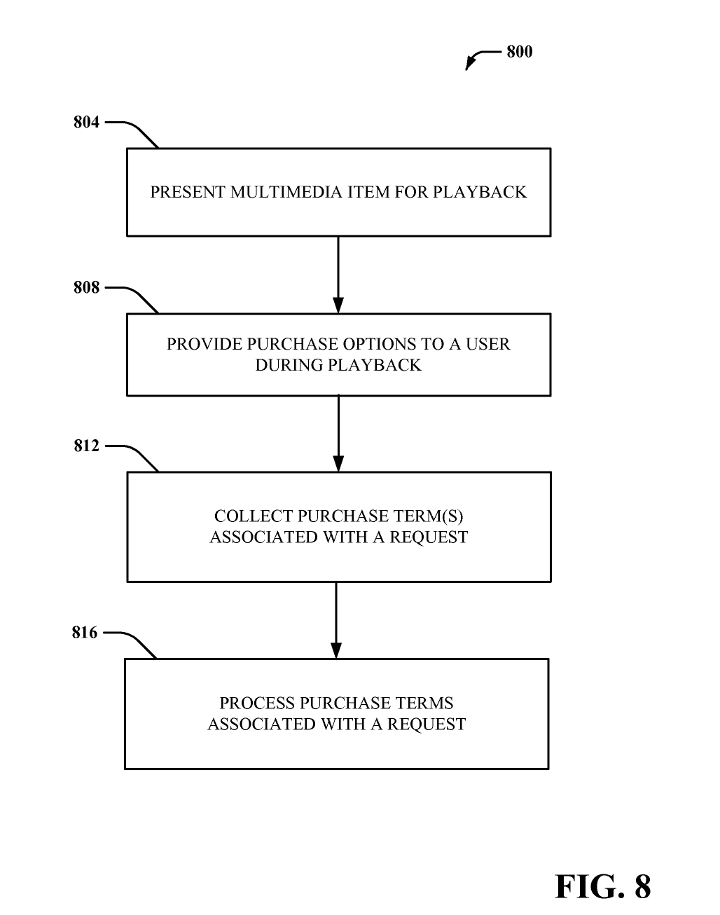

Referring now to FIG. 8, presented is an exemplary non-limiting embodiment of a method 800 for purchasing and/or altering a purchase during multimedia playback, in accordance with various aspects of this disclosure. At 804, a multimedia item is presented for playback (e.g., via the multimedia device 410). For example, a multimedia item is played-back via a multimedia item player as a video item, an audio item, a text item, and the like.

At 808, a purchase option is provide via an interfaced (e.g., by the multimedia device 410). For example, a purchase option can be presented as a component in a multimedia player (e.g., embedded in a multimedia player interface).

At 812, a purchase term is selected (e.g., a user selects an alteration of a multimedia item purchase agreement, a new multimedia item to purchase, etc.) to be sent as a request. In an aspect, one or more purchase terms can be presented (e.g., as a drop-down-menu) for a user to select.

At 816, a requested purchase term is processed (e.g., via the server device 150). For example, a request can be sent (e.g., via the network 140) to a server (e.g., the server device 150) and the request can be processed, as described in various aspects of this disclosure.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

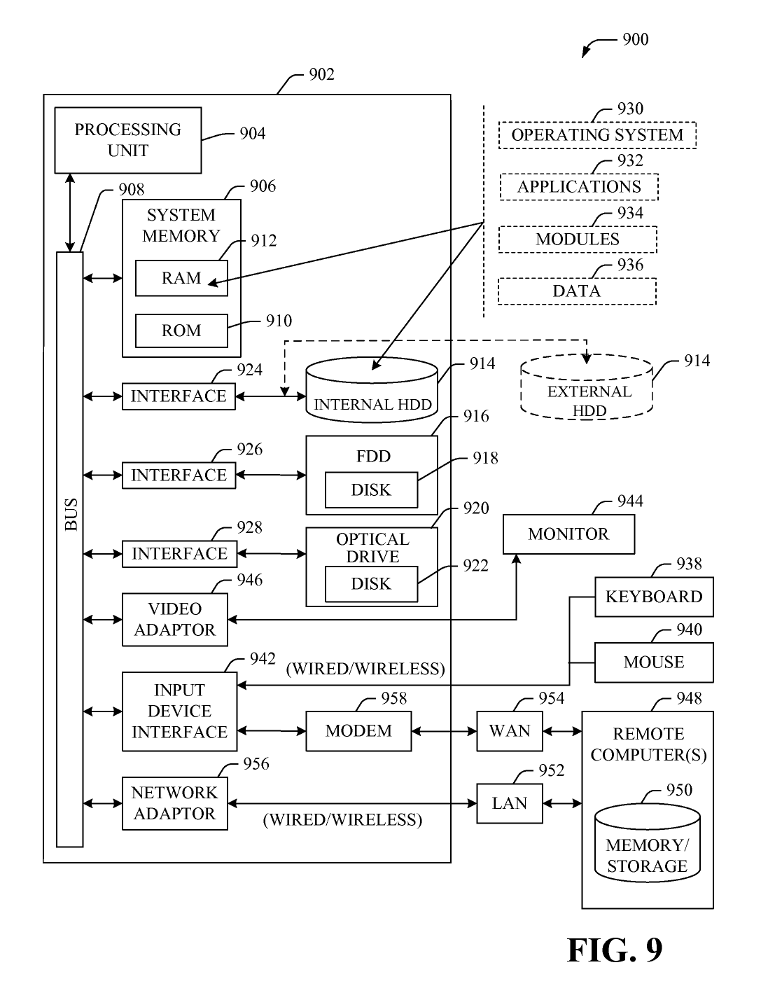

Referring now to FIG. 9, there is illustrated a block diagram of a computer operable to execute the disclosed communication architecture. In order to provide additional context for various aspects of the subject specification, FIG. 9 and the following discussion are intended to provide a brief, general description of a suitable computing environment 900 in which the various aspects of the specification can be implemented. While the specification has been described above in the general context of computer-executable instructions that can run on one or more computers, it is noted that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments, including cloud-computing environments, where certain tasks are performed by remote processing devices that are linked through a communications network. In a distributed computing environment, program modules can be located in both local and remote memory storage devices.

Computing devices can include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically include (and/or facilitate the transmission of) computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media.

With reference again to FIG. 9, the example environment 900 for implementing various aspects of the specification includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system is stored in a non-volatile memory 910 such as ROM, erasable programmable read only memory, electrically erasable programmable read only memory, which basic input/output system contains the basic routines that help to transfer information between elements within the computer 902, such as during startup. The RAM 912 can also include a high-speed RAM such as static RAM for caching data.

The computer 902 further includes an internal hard disk drive 914 (e.g., EIDE, SATA), which internal hard disk drive 914 can also be configured for external use in a suitable chassis (not shown), a magnetic floppy disk drive 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject specification.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to a HDD, a removable magnetic diskette, and a removable optical media such as a CD or DVD, it should be noted by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods of the specification.

A number of program modules can be stored in the drives and RAM 912, including an operating system 930, one or more application programs 932, other program modules 934 and program data 936. All or portions of the operating system, applications, modules, and/or data can also be cached in the RAM 912. It is noted that the specification can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) can include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 can operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network 952 and/or larger networks, e.g., a wide area network 954. Such local area network and wide area network networking environments are commonplace in offices and companies, and facilitate enterprise-wide computer networks, such as intranets, all of which can connect to a global communications network, e.g., the Internet.

When used in a local area network networking environment, the computer 902 is connected to the local network 952 through a wired and/or wireless communication network interface or adapter 956. The adapter 956 can facilitate wired or wireless communication to the local area network 952, which can also include a wireless access point disposed thereon for communicating with the wireless adapter 956.

When used in a wide area network environment, the computer 902 can include a modem 958, or is connected to a communications server on the wide area network 954, or has other means for establishing communications over the wide area network 1154, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It is noted that the network connections shown are example and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. In an example embodiment, wireless communications can be facilitated, for example, using Wi-Fi, Bluetooth™, Zigbee, and other 802.XX wireless technologies. Thus, the communication can be a predefined structure as with a conventional network or simply an ad hoc communication between at least two devices.

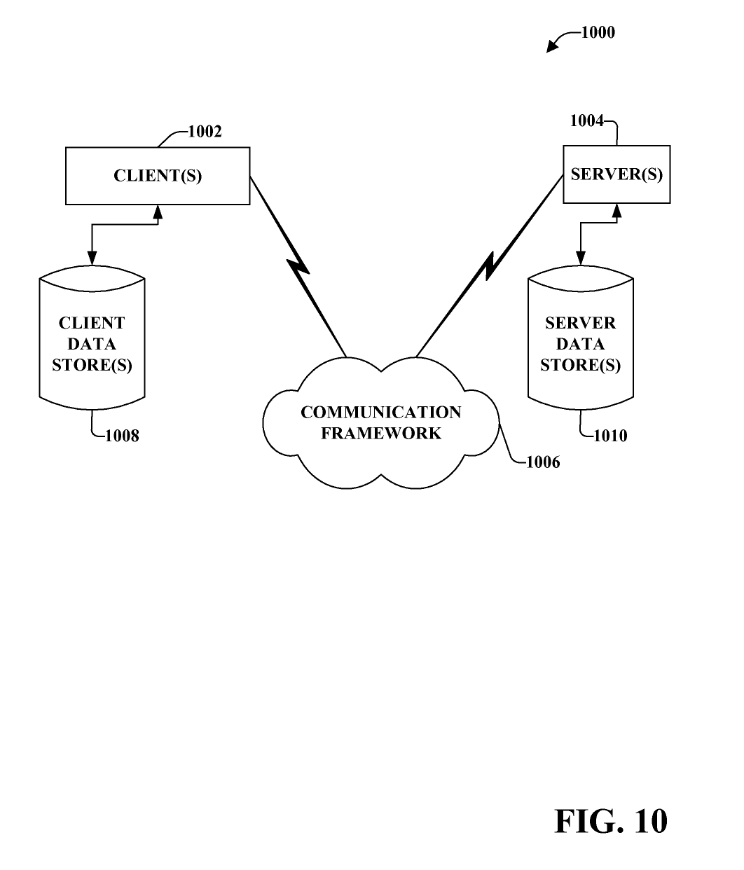

Referring now to FIG. 10, there is illustrated a schematic block diagram of a computing environment 1000 in accordance with this specification. The system 1000 includes one or more client(s) 1002, (e.g., computers, smart phones, tablets, cameras, PDA's). The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware or hardware in combination with software (e.g., threads, processes, computing devices). The servers 1004 can house threads to perform transformations by employing aspects of this disclosure, for example. One possible communication between a client 1002 and a server 1004 can be in the form of a data packet adapted to be transmitted between two or more computer processes wherein data packets may include coded media items and/or aggregated media items. The data packet can include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

In one implementation, a server 1004 can transfer an encoded file, (e.g., network selection policy, network condition information, etc.), to client 1002. Client 1002 can store the file, decode the file, or transmit the file to another client 1002. It is noted, that a server 1004 can also transfer uncompressed file to a client 1002 and client 1002 can compress the file in accordance with the disclosed subject matter. Likewise, server 1004 can encode information and transmit the information via communication framework 1006 to one or more clients 1002.

As mentioned above, while exemplary non-limiting embodiments have been described in connection with various computing devices and network architectures, the underlying concepts may be applied to any network system and any computing device or system.

In addition, there are multiple ways to implement the same or similar functionality, e.g., an appropriate application programming interface (API), tool kit, driver source code, operating system, control, standalone or downloadable software object, etc., which enables applications and services to take advantage of techniques, provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described infra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” can include one criterion, or many criteria.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory to store computer executable components; and
a processor, communicatively coupled to the memory, that facilitates execution of the computer executable components, the computer executable components, comprising:
an account manager component configured to manage user account data representing a user account, the user account data comprising purchase data representing a purchase entry associated with a first media item;
a billing component configured to receive a request to alter the purchase entry of the purchase data;
a credit component configured to determine a credit amount to be applied to the user account as represented by the user account data based on the purchase entry and the request; and
a content manager component configured to alter access data representing an access right, associated with the user account, to the first media item.

2. The system of claim 1, wherein the first media item comprises a video item, an audio item, or a text item.

3. The system of claim 1, wherein the billing component is configured to apply the credit amount to the user account.

4. The system of claim 1, wherein the content manager component is configured to switch the access right between an ownership right, indicating permanent ownership, and a rental right, indicating temporary ownership.

5. The system of claim 4, wherein the credit component is configured to determine the credit amount based on a period indicating an elapsed length of time starting from a first time when a rental right associated with the user account was created and ending at a second time when the request was received.

6. The system of claim 1, wherein the request comprises data indicating a request to purchase a second media item.

7. The system of claim 6, wherein the account manager is configured to create a second purchase entry according to the data indicating the request to purchase the second media item, and the content manager component alters the access right to the first media item and alters an access right to the second media item.

8. The system of claim 7, wherein the account manager is configured to create the second purchase entry and alter the access right to the first media item and the access right to the second media item, during playback of the first media item.

9. The system of claim 6, wherein the credit component is configured to determine the credit amount based on a type associated with the request to purchase, the type comprising a rent request type or a buy request type.

10. The system of claim 6, wherein the credit component is configured to determine the credit amount based on a relationship between the first media item and the second media item.

11. The system of claim 1, wherein the content manager component is configured to deliver the first media item to a device associated with the user account.

12. The system of claim 1, wherein the billing component is configured to receive the request during playback of the first media item.

13. The system of claim 12, wherein the content manager component is configured to alter the access right to the first media item during playback.

14. A method, comprising:
employing at least one processor executing computer executable instructions stored on at least one non-transitory computer readable medium to perform operations, comprising:
receiving a request to alter one or more terms of a purchase agreement associated with a first media item;
altering an access right associated with the first media item based on the one or more terms; and
determining a credit amount based on the request and the one or more terms of the purchase agreement.

15. The method of claim 14, wherein the receiving the request comprises receiving purchase terms associated with a second media item.

16. The method of claim 15, wherein the determining the credit comprises determining a relationship between the first media item and the second media item.

17. The method of claim 15, further comprising:
creating an access right to the second media item.

18. The method of claim 14, wherein the access right is switched between a rental right indicating a temporary access right and an ownership right indicating a permanent access right.

19. The method of claim 14, wherein the receiving, the altering, and the determining occur during playback of the first media item.

20. A tangible computer-readable storage medium comprising computer-readable instructions that, in response to execution, cause a computing system including a processor to perform operations, comprising:
receiving a request to alter a purchase agreement associated with a media item;
altering an access right associated with the media item based on the request; and
determining a credit amount based on the request.

21. The tangible computer-readable storage medium of claim 20, further comprising:
receiving a request to purchase a disparate media item.

22. The tangible computer-readable storage medium of claim 20, wherein the altering switches between a type of access right, and the type comprises a rental right or an owner right.

23. The tangible computer-readable storage medium of claim 20, wherein the receiving, the altering, and the determining are performed during playback of the media item.
